(19) United States
(12) Patent Application Publication
(10) Pub. No.: US 2014/0053861 A1
(43) Pub. Date: Feb. 27, 2014

(54) Hairdressing Aid

(71) Applicant: Adil Hanna Hirmiz, Brunswick East (AU)

(72) Inventor: Adil Hanna Hirmiz, Brunswick East (AU)

(21) Appl. No.: 13/592,287

(22) Filed: Aug. 22, 2012

(51) Int. Cl. A45D 24/36; G01C 9/02

(52) U.S. Cl. 132/213.1; 33/334

(57) ABSTRACT

A hairdressers comb has a recess which houses a plug containing a bubble level. The level indicates the vertical, horizontal and 45 degrees positions of the comb by means of a circular passage in the comb with a hexagonal or octagonal outer wall by which the bubble position can be checked. The plug is mounted in the comb to allow rotation on the long axis of the comb enabling the user to tilt the plug to lie at 90 degrees to the plane of the comb.

### TECHNICAL FIELD

This invention concerns implements for hair care, especially the execution of styling cuts where the straightness of the cut is visible as in a fringe or the lower edge of shoulder length hair.

### BACKGROUND

Hairdressers tend to use a comb and scissors or a comb and clipper because the comb is a reference plane and edge which reveals the curvature of the facial features, shape of the head or curl of the hair. It is able to do this because the teeth pass through the hair allowing the hair to lie next to the comb surface while the scissors or clippers follow the comb surface reproducing the straightness of the comb in the cut which is made.

Hairdressers are at a disadvantage when symmetry in cutting is attempted, for example in achieving accurate cuts at the left hand side to match the right hand side because the cut is made in two stages. If their arm angle varies or their fingers move unduly the symmetry is lost and a fresh remedial cut risks shortening the hair unduly.

### SUMMARY OF INVENTION

The apparatus aspect of the invention provides a hair care implement for contacting hair and indicating a cutting axis to the user comprising a comb with a recess in the plane of the comb, a plug mounted in the recess which contains a bubble level, the plug being free to rotate in and out of the plane of the comb for selecting a mode of operation.

The usefulness of the implement resides in its ‘memory’ in that if the subject moves or the hair is disturbed the implement can be placed opposite the head or body and the axis checked repeatedly before finally cutting the hair.

The teeth may be uniform or divided into coarse and fine as in an ordinary comb.

Conveniently the level is a bubble level because in salons there is usually adequate lighting enabling an operator to read the level quickly. For operators who drop implements, an electronic level is more practical.

The plug is central or at one end of the comb.

The plug may be arrestable at 90 degrees to the plane of the comb allowing the operator to hold the combs spine axis horizontally at 90 degrees to the hair.

The bubble level is transparent, being a circular passage in the plug, having an outer wall with a pair of convergent faces separated by a horizontal face which is parallel to the axis of the spine. The convergent faces both lie at 90 degrees to each other and 45 degrees to the horizontal face.

The length of each of the three faces preferably exceeds the width of the bubble.

The faces are conveniently of equal length and the bubble width may be 80% of the length of the face.

The inner wall of the bubble level may be circular and the bubble extends from wall to wall across the lumen of the passage. The outer wall of the passage may be octagonal or hexagonal in outline.

The passage has a filling port extending to the surface of the plug for charging the passage with liquid, the port being closed by a seal.

A second apparatus aspect provides a bubble level for a manual implement which indicates 45 degrees comprising a transparent plug for mounting in or on the implement, a circular passage in the plug having an inner wall and an outer wall which is hexagonal or octagonal in outline and a port connecting the passage to the plug surface for the introduction of liquid.

### BRIEF DESCRIPTION OF DRAWINGS

One embodiment of the invention is now described with reference to the accompanying drawings, in which:

FIG. 1 is a side view of the implement lying at 45 degrees.

FIG. 2 is a perspective of the implement lying horizontally with the plug at 90 degrees to the teeth.

FIG. 3 is an end view of the implement as shown in FIG. 1.

FIG. 4 is a side view with the implement with the plug in the same plane as the teeth.

FIG. 5 is a plan view of the implement in the horizontal position shown in FIG. 2.

### DESCRIPTION OF EMBODIMENTS

Referring now to the drawings, the implement consists of two different mouldings, the comb part having a spine 2 like a blade with thirty-nine coarse teeth 4 and forty-nine fine teeth 6. The comb part is 200 mm long and has a central crescent-shaped recess 8 bordered by an arcuate ridge 10. The ridge accommodates a disc shaped plug 12 about 20 mm diameter with parallel flat faces 14. Plug 12 has a pair of diametric trunnions 16 which engage a pair of shallow cavities 18 lying in the ridge 10 on the axis S of the spine (see FIG. 4). The plug is free to rotate to lie at 90 degrees to the plane of the comb (see FIG. 2). Friction between the trunnions and the ridge cavities ensure that the plug remains in whatever rotational position the operator gives it.

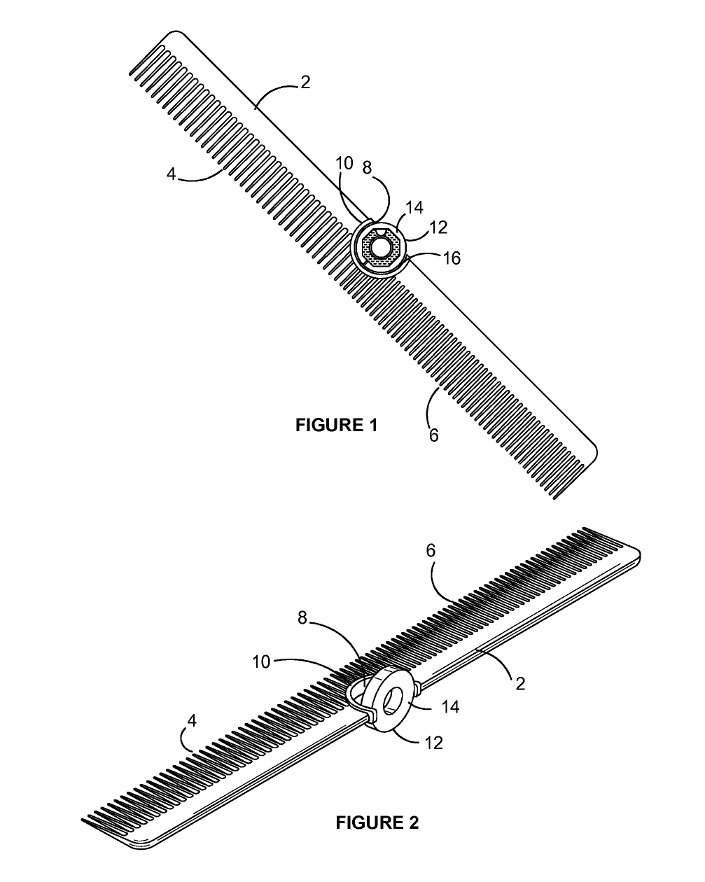

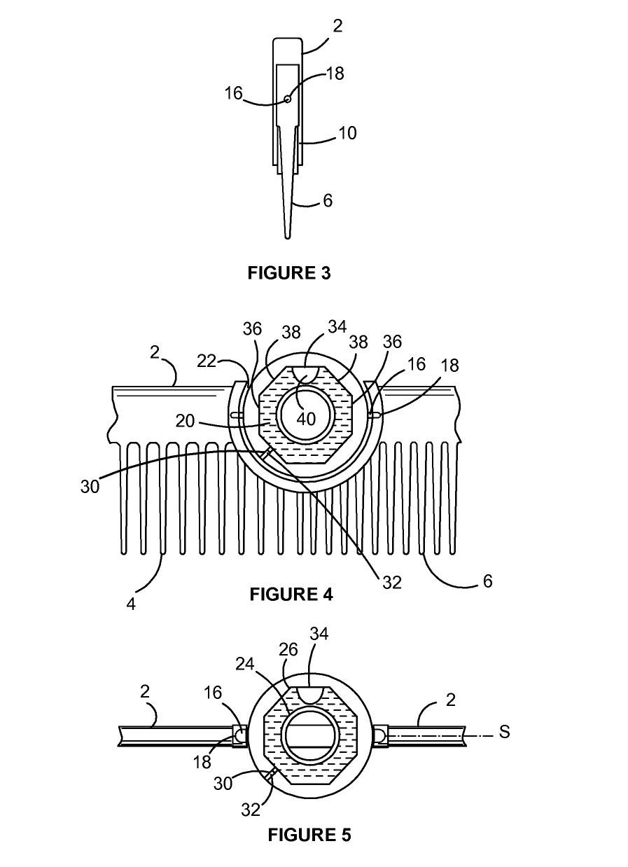

The plug is a separate moulding made of transparent plastic. It is in turn composed of two halves in order to create an internal bubble passage 20 surrounding central aperture 22. The inner wall 24 of the bubble passage is circular, whereas the outer wall 26 is octagonal. Filler port 30 extends from the surface of the plug into the passage whereby coloured liquid is introduced into the passage and retained by a seal 32. The outer wall of the passage is octagonal in order to present a horizontal face 34, two vertical faces 36 and two diagonal faces 38 at 90 degrees to each other. These faces are about 1 mm longer than the width of bubble 40 (see FIG. 4) enabling the operator to hold the spine of the implement horizontally in the modes shown in both FIG. 4 and FIG. 5. This choice is useful when cutting skeins of hair. The implement can indicate a 45 degrees axis on the left and right hand sides of the subjects head because the faces of the octagonal wall are symmetrical (see FIG. 1).

The comb part is a 40% carbon filled nylon coated with white gloss paint. The plug is made of polymethyl methacrylate. Polymers other than nylon are also useful.

In a variant, the recess and plug are at one end of the comb.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

Persons skilled in the art will comprehend the usefulness of a compact component such as the plug in other tools, in that it indicates not only horizontal and vertical but 45 degrees. This would be useful in rules used for setting out sheet materials in building and cabinet work and rules for setting out signage and marking out fabric for awnings and the like.

1. A hair care implement for contacting hair and indicating a cutting axis to the user comprising a generally planar comb with a longitudinal axis and a recess in the plane of the comb, a plug mounted in the recess which contains a bubble level, the plug being free to rotate in and out of the plane of the comb around the longitudinal axis for selecting a mode of operation while remaining parallel to the longitudinal axis.

2. A hair care implement as claimed in claim 1, wherein the plug is situated centrally.

3. A hair care implement as claimed in claim 1, wherein the comb has an end and an opposite end and the plug is at one of the ends.

4. A hair care implement as claimed in claim 1, wherein the comb has a spine axis and the plug is arrestable at 90 degrees to the plane of the comb allowing the operator to hold the combs spine axis horizontally at 90 degrees to the hair.

5. A hair care implement as claimed in claim 4, wherein the bubble level is transparent and defines a circular passage in the plug, having an outer wall with a pair of convergent faces separated by a horizontal face which is parallel to the axis of the spine.

6. A hair care implement as claimed in claim 5, wherein the convergent faces both lie at 90 degrees to each other and 45 degrees to the horizontal face.

7. A hair care implement as claimed in claim 5, wherein the length of each of the three faces exceeds the width of the bubble.

8. A hair care implement as claimed in claim 7, wherein the faces are of equal length and the bubble width is 80% of the length of the face.

9. A hair care implement as claimed in claim 5, wherein the passage has an inner wall which is circular and the bubble extends from wall to wall across the lumen of the passage.

10. A hair care implement as claimed in claim 5, wherein the outer wall of the passage is one of an octagonal or hexagonal shape in outline.

11. A hair care implement as claimed in claim 5, wherein the passage in turn defines a filling port extending to the surface of the plug for charging the passage with liquid, the port being closed by a seal.

12. A bubble level for a manual implement which indicates 45 degrees, comprising:
a transparent plug for mounting in or on the implement, the plug defining a circular passage in the plug, and
the passage having an inner wall and an outer wall which is hexagonal or octagonal in outline, and
a port connecting the passage to the plug surface for the introduction of liquid.
